(19) United States
(12) Patent Application Publication
(10) Pub. No.: US 2003/0229577 A1
(43) Pub. Date: Dec. 11, 2003

(54) System and method for brokering and managing automobile sales leads

(76) Inventor: Jeffrey Albert Nabel, Capistrano Beach, CA (US)

Correspondence Address: Joseph A. Yanny, Yanny & Smith, 1925 Century Park East, Suite 1260, Los Angeles, CA, 90067, US

(21) Appl. No.: 10/395,653

(22) Filed: Mar. 24, 2003

Related U.S. Application Data
(60) Provisional application No. 60/387,688, filed on Jun. 10, 2002.

(51) Int. Cl. G06F 17/60

(52) U.S. Cl. 705/37

(57) ABSTRACT

The present invention is an electronic, Internet-based system, and method for practicing same, which provides a potential buyer of an automobile the ability to search for, compare, identify and make an offer to purchase an automobile, which offer is transmitted to an automobile dealer. In the inventive electronic, Internet-based system, a potential buyer accesses a first user interface through a hyper-link directly from a participating automobile dealer's Internet site or from an advertisement tied to an automobile dealer. The act of accessing the first user interface through either form of hyper-link designates said automobile dealer as a target automobile dealer for the current potential buyer. By accessing the first user interface, a potential buyer may: (i) configure the characteristics and options available for a desired automobile; (ii) view available pricing information on the selected automobile configuration; and (iii) make an offer to the target automobile dealer for the purchase of the selected automobile having the selected configuration, generating an offer transmittal to be sent to the target automobile dealer. After the target automobile dealer receives the offer transmittal, the target automobile dealer may contact the potential buyer directly to discuss the offer for the configured automobile. During such direct contact, the potential buyer is in a bargaining position which provides more comfort, advantages, and bargaining power to the potential buyer.

### CROSS-REFERENCE TO RELATED APPLICATION

This application claims the benefit of U.S. Provisional Application No. 60/387,688, filed Jun. 10, 2002..

### STATEMENT RE: FEDERALLY SPONSORED RESEARCH AND DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

The present invention relates to a system, and a method of practicing such system, for brokering and managing automobile sales leads, and, more particularly, to an electronic, Internet-based system with interactive features that allows prospective buyers of automobiles to search for, compare, identify, and offer to purchase automobiles.

2. Background

In recent years, there have been numerous electronic, Internet-based systems and methods devised for managing automobile sales leads, by allowing prospective buyers to search for, identify, compare, and request an offer for sale of various automobile configurations. In each of these systems, a sales lead is generated which identifies, for either a single automobile dealer or a group of automobile dealers, a particular configuration of automobile and the identity of a prospective buyer. Different electronic, Internet-based systems have been employed to accomplish such tasks, including systems which provide invoice and MSRP pricing information. Such systems require the automobile dealer to contact the prospective buyer prior to the commencement of any price negotiations.

No prior system has provided a feature whereby a prospective buyer could make an offer for the purchase of an automobile, where such offer is communicated to an automobile dealer without the need for the dealer to initiate contact with the prospective buyer prior to commencing negotiations. Such system would allow the prospective buyer to obtain an advantage in negotiations leading to the purchase of an automobile.

It is therefore desirable to provide an electronic, Internet-based system, and method for implementing such system, which provides a prospective buyer of an automobile not only the ability to search for, compare, and identify automobiles, but to make an offer to purchase an automobile, which offer is transmitted to an automobile dealer. Such a system would provide a prospective buyer with a greater amount of convenience and bargaining power in considering and purchasing an automobile than prior art systems. Ultimately, the provider of such a system, generally a lead provider, will be able to provide a more satisfactory experience to both the prospective buyer, in the form of increased convenience and satisfaction, and the automobile dealer, in the form of increased sales and potentially repeat business from satisfied customers.

### BRIEF SUMMARY OF THE INVENTION

It is therefore desirable to provide an electronic, Internet-based system which provides a prospective buyer of an automobile the ability to search for, compare, identify and make an offer to purchase an automobile, which offer is transmitted to an automobile dealer. Similarly, it is desirable to provide a method for practicing such electronic, Internet-based system.

Such electronic, Internet-based system includes a computer network containing: (i) information about a plurality of automobile dealers in an information database; (ii) a user interface for a potential buyer to access said information database; and (iii) another user interface for one or more of a plurality of automobile dealers to access said information database. A potential buyer may access said user interface through a plurality of means including: (i) a hyper-link directly from a participating automobile dealer's Internet site; (ii) a hyper-link directly from an e-mail solicitation produced by a participating automobile dealer; (iii) a hyperlink from a third-party's Internet site; (iv) a hyperlink from a banner advertisement on a third-party's Internet site; (v) a hyperlink from a listing showing results from an Internet search engine routine; or (vi) any other form of hyperlink, so long as any of the above hyperlinks point to the first user interface (12) and can identify a participating automobile dealer. The act of accessing said user interface through any form of hyper-link identifies said participating automobile dealer as a target automobile dealer for the current potential buyer.

The user interface permits a potential buyer to: (i) configure the characteristics and options available for a desired automobile; (ii) view available pricing information on the selected automobile configuration; and (iii) make an offer to the target automobile dealer for the purchase of the selected automobile having the selected configuration. The act of making an offer generates an offer transmittal to be sent to the target automobile dealer or stored in the information database for later access by the target automobile dealer.

In every step above, where a potential buyer is using the user interface to interact with the information database, the potential buyer is directed by pre-recorded voice prompts to assist the potential buyer in the selection of its automobile configuration and in the making of an offer.

The other user interface permits a participating automobile dealer to access said information database. A participating automobile dealer may only view that information which is sent to that participating automobile dealer, i.e., only a target automobile dealer may view offer transmittals made to such target automobile dealer.

After the computer network provides the offer transmittal to the target automobile dealer, the target automobile dealer may contact the potential buyer directly to discuss the offer for the configured automobile. During such direct contact, the potential buyer is in a bargaining position which provides more comfort, advantages, and bargaining power to the potential buyer.

### BRIEF DESCRIPTION OF THE DRAWINGS

FIG. 1 depicts a diagram of the system of the present invention.

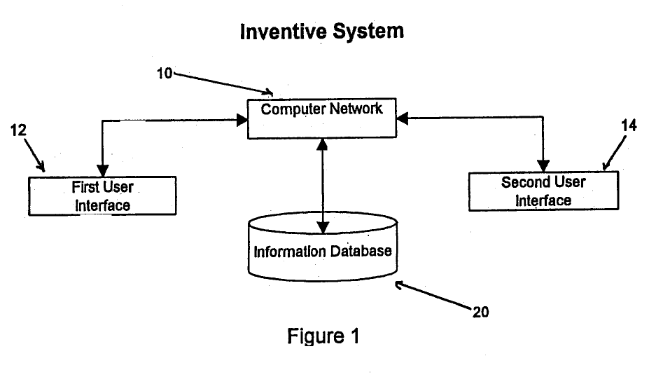

FIG. 2 depicts a flowchart of the method of the present invention.

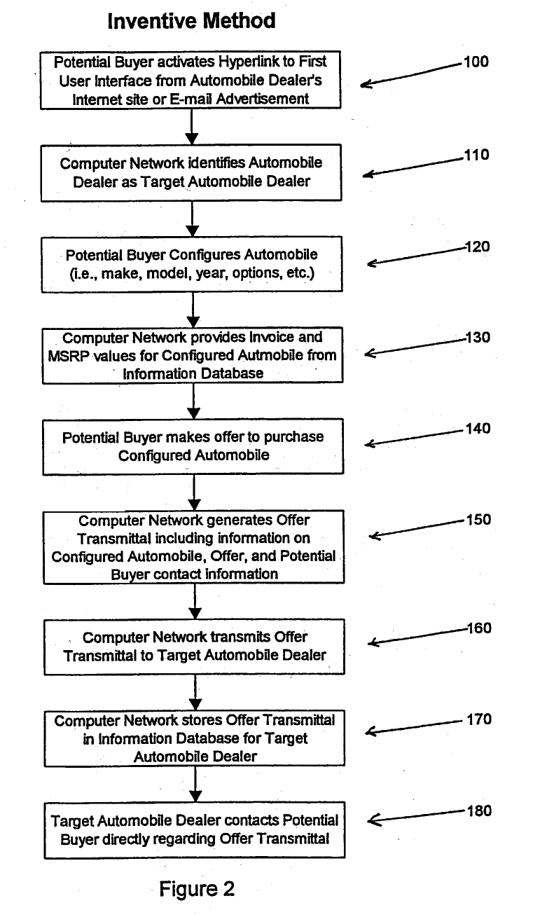

### DETAILED DESCRIPTION OF THE INVENTION

In the preferred embodiment of the present invention relating to an electronic, Internet-based system, and method of practicing such system, for brokering and managing automobile sales leads, a potential buyer is permitted to search for, compare, and identify an automobile configuration, and initiate the negotiation process for the purchase of an automobile by making an offer to a targeted automobile dealer. The inventive system is based upon an information database (20) contained on a computer network (10).

The computer network (10) provides first and second user interfaces (12 and 14) to permit potential buyers and automobile dealers to access the information database (20). Potential buyers access the information database (20) through the first user interface (12), which is in electronic communication with the computer network (10) via the Internet. There are a plurality of means through which a potential buyer may reach the first user interface (12). In the preferred embodiment of the present invention, a potential buyer accesses the first user interface (12) by activating an electronic connection (100) to the first user interface (12). Such electronic connection may take the form of: (i) a hyperlink from an automobile dealers' Internet site; (ii) a hyperlink from an advertising e-mail generated, authorized, or otherwise provided by said automobile dealer; (iii) a hyperlink from a third-party's Internet site; (iv) a hyperlink from a banner advertisement on a third-party's Internet site; (v) a hyperlink from a listing showing results from an Internet search engine routine; or (vi) any other form of hyperlink, so long as any of the above hyperlinks point to the first user interface (12) and can identify a participating automobile dealer. The activation of any form of hyperlink directs the potential buyers' Internet browser to the first user interface (12).

Once a potential buyer's Internet browser is directed to the first user interface (12), the information database (20) identifies, as a target automobile dealer, the automobile dealer which owns the Internet site or the e-mail advertisement from which the potential buyer linked (110). An offer transmittal, described more fully below, which is generated by the computer network (10) after the potential buyer makes an offer to purchase a configured automobile, is transmitted only to the target automobile dealer.

By accessing the first user interface (12), a potential buyer may begin configuring an automobile (120). Configuring an automobile involves selecting various criteria about an automobile including make, model, year, color, transmission, as well as any other options that are available for a specific make, model, and year of automobile. Such configuration of an automobile results in a product for which the computer network (10) may calculate the invoice and MSRP prices from the information database (20). The computer network (10) then provides the invoice and MSRP prices to the potential buyer (130) through the first user interface (12).

Once the potential buyer configures an automobile and the computer network (10) provides the invoice and MSRP prices, the potential buyer may make an offer to purchase the automobile as configured (140). When the potential buyer makes an offer, an offer transmittal is generated (150). The offer transmittal includes: information on the automobile as configured; the offer that the potential buyer made; and contact information for the potential buyer. Such offer transmittal is then provided to the target automobile dealer.

During each of the above steps, the potential buyer is guided by textual instructions which are provided by the information database (20) and displayed on a computer monitor connected to the Internet and in communication with the first user interface (12). In addition to the textual instructions, the information database (20) also provides verbal instructions in the form of prerecorded voice prompts. In conjunction with the textual instructions, the verbal instructions guide the potential buyer through the automobile configuration process and the offer transmittal process.

An offer transmittal is stored (170) in the information database (20) and provided to the target automobile dealer in one of two ways. The computer network may send an electronic transmission to the target automobile dealer, which transmission includes information concerning the offer transmittal (160). The electronic transmission may consist of a facsimle, e-mail, instant message, or other commonly accepted method of sending an electronic communication. Alternatively, an automobile dealer may access the information database (20) through the second user interface (14), which is in electronic communication with the computer network (10) via the Internet. When an automobile dealer accesses the information database (20) through the second user interface (14), the automobile dealer has access to all offer transmittals for which the automobile dealer is the target automobile dealer.

Once the target automobile dealer receives an offer transmittal prepared by the computer network (10) for a potential buyer, the target automobile dealer may contact the potential buyer directly (180). During such direct contact, the potential buyer is in a much more comfortable, advantageous, and powerful bargaining position. The potential buyer realizes these benefits for a plurality of reasons. First, the potential buyer is negotiating from the comfort of their own home or office. Second, in the operation of the present invention, the potential buyer is more likely dealing with a fleet manager rather than, when walking in off the street, a salesperson who exerts pressure on the potential buyer to make a purchase in order to increase the salesperson's commission. Third, the potential buyer will not be subject to the intimidation inherent in the typical situation where the sales person repeatedly goes to the fleet manager in the attempt to obtain a “better deal” for the potential buyer.

While the foregoing description has been particularly described in conjunction with a specific preferred embodiment, it will be appreciated by those with ordinary skill in the art that the description of the preferred embodiment set forth above is for illustrative purposes only. It is anticipated that the contemplated claims will embrace any such alternatives, modifications and variations as falling within the true scope and spirit of the present invention.

I claim:

1. An Internet-based computer network providing a prospective buyer of an automobile the ability to search for, compare, identify and make an offer to purchase an automobile from a participating automobile dealer comprising:
(i) an information database containing information about automobiles and automobile dealers on said computer network;
(ii) a first user interface in electronic communication with the computer network to permit the prospective buyer to access said information database;
(iii) wherein the prospective buyer accesses the first user interface by activating a hyperlink which identifies the participating automobile dealer as a target automobile dealer;
(iv) wherein the first user interface permits the potential buyer to use the information contained in the information database by configuring characteristics and options available for a desired automobile, generating a selected automobile configuration, viewing pricing information contained in the information database specific to the selected automobile configuration, and generating an offer transmittal for the purchase of an automobile, including an automobile configuration, an offer price, and contact information; and
(v) a second user interface in electronic communication with the computer network to permit the participating automobile dealer to access said information database.

2. The Internet-based computer network of claim 1 wherein the prospective buyer accesses the first user interface by activating a hyper-link directly from the participating automobile dealer's Internet site.

3. The Internet-based computer network of claim 1 wherein the prospective buyer accesses the first use interface by activating a hyper-link directly from an e-mail solicitation distributed by the participating automobile dealer.

4. The Internet-based computer network of claim 1 wherein the prospective buyer accesses the first user interface by activating a hyperlink identifying the participating automobile dealer on a third party's Internet site.

5. The Internet-based computer network of claim 1 wherein the prospective buyer accesses the first user interface by activating a hyperlink in a banner advertisement identifying the participating automobile dealer on a third-party's Internet site.

6. The Internet-based computer network of claim 1 wherein the offer transmittal is sent to the target automobile dealer via electronic communication.

7. The electronic, Internet-based computer network of claim 6 wherein the offer transmittal is sent to the target automobile dealer by e-mail.

8. The Internet-based computer network of claim 1 wherein the offer transmittal is stored in the information database.

9. The Internet-based computer network of claim 8 wherein the target automobile dealer accesses the second user interface to review an offer transmittal stored in the information database.

10. The Internet-based computer network of claim 1 wherein text prompts in the first user interface direct the potential buyer using the information contained in the information database.

11. The Internet-based computer network of claim 10 wherein the text prompts in the first user interface direct the potential buyer in configuring the characteristics and options of the selected automobile configuration.

12. The Internet-based computer network of claim 10 wherein the text prompts in the first user interface direct the potential buyer in generating the offer transmittal.

13. The Internet-based computer network of claim 1 wherein pre-recorded voice prompts in the first user interface direct the potential buyer using the information contained in the information database.

14. The Internet-based computer network of claim 13 wherein the pre-recorded voice prompts in the first user interface direct the potential buyer in configuring the characteristics and options of the selected automobile configuration.

15. The Internet-based computer network of claim 13 wherein the pre-recorded voice prompts in the first user interface direct the potential buyer in generating the offer transmittal.

16. The Internet-based computer network of claim 1 wherein the participating automobile dealer using the second user interface may only view information contained in the information database for which the automobile dealer is identified as the target automobile dealer.

17. The Internet-based computer network of claim 1 wherein the offer price contained in the offer transmittal is a final sales price.

18. A method of selling automobiles via an Internet-based computer network comprising:
(i) providing an information database containing information about automobiles and automobile dealers on said computer network;
(ii) providing a first user interface in electronic communication with the computer network to permit a prospective buyer to access said information database;
(iii) wherein the prospective buyer accesses the first user interface by activating a hyperlink which identifies the participating automobile dealer as a target automobile dealer;
(iv) wherein the first user interface permits the potential buyer to use the information contained in the information database by configuring characteristics and options available for a desired automobile, generating a selected automobile configuration, viewing pricing information contained in the information database specific to the selected automobile configuration, and generating an offer transmittal for the purchase of an automobile, including an automobile configuration, an offer price, and contact information; and
(v) providing a second user interface in electronic communication with the computer network permitting a participating automobile dealer to access said information database.

19. The method of selling automobiles via an Internet-based computer network of claim 18 further comprising providing a hyperlink directly from the participating automobile dealer's Internet site whereby the prospective buyer accesses the first user interface.

20. The method of selling automobiles via an Internet-based computer network of claim 18 further comprising providing a hyperlink directly from an e-mail solicitation distributed by the participating automobile dealer whereby the prospective, buyer accesses the first user interface.

21. The method of selling automobiles via an Internet-based computer network of claim 18 further comprising providing a hyperlink which identifies the participating automobile dealer on a third party's Internet site whereby the prospective buyer accesses the first user interface.

22. The method of selling automobiles via an Internet-based computer network of claim 18 further comprising providing a hyperlink in a banner advertisement which identifies the participating automobile dealer on a third-party's Internet site whereby the prospective buyer accesses the first use interface.

23. The method of selling automobiles via an Internet-based computer network of claim 18 further comprising sending the offer transmittal to the target automobile dealer via electronic communication.

24. The method of selling automobiles via an Internet-based computer network of claim 23 further comprising sending the offer transmittal to the target automobile dealer by e-mail.

25. The method of selling automobiles via an Internet-based computer network of claim 18 further comprising storing the offer transmittal in the information database.

26. The method of selling automobiles via an Internet-based computer network of claim 25 further comprising the step of the target automobile dealer accessing the second user interface to review an offer transmittal stored in the information database.

27. The method of selling automobiles via an Internet-based computer network of claim 18 further comprising providing text prompts in the first user interface to direct the potential buyer using the information contained in the information database.

28. The method of selling automobiles via an Internet-based computer network of claim 27 further comprising providing text prompts in the first user interface to direct the potential buyer in configuring the characteristics and options of the selected automobile configuration.

29. The method of selling automobiles via an Internet-based computer network of claim 27 further comprising providing text prompts in the first user interface to direct the potential buyer in generating the offer transmittal.

30. The method of selling automobiles via an Internet-based computer network of claim 18 further comprising providing pre-recorded voice prompts in the first user interface to direct the potential buyer using the information in the information database.

31. The method of selling automobiles via an Internet-based computer network of claim 30 further comprising providing pre-recorded voice prompts in the first user interface to direct the potential buyer in configuring the characteristics and options of the selected automobile configuration.

32. The method of selling automobiles via an Internet-based computer network of claim 30 further comprising providing pre-recorded voice prompts in the first user interface to direct the potential buyer in generating the offer transmittal.

33. The method of selling automobiles via an Internet-based computer network of claim 18 further comprising making the information contained in the information database accessible through the second user interface only to the participating automobile dealer identified as the target automobile dealer for the information.

34. The method of selling automobiles via an Internet-based computer network of claim 18 further comprising making the offer price contained in the offer transmittal a final sales price.
